(19) United States
(12) Patent Application Publication
(10) Pub. No.: US 2008/0197071 A1
(43) Pub. Date: Aug. 21, 2008

(54) Nano Composite Hollow Fiber Membrane and Method of Manufacturing the Same

(75) Inventors: Moo Seok Lee, Seoul (KR); Kwang Jin Lee, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: Kolon Industries, Inc., Kwachkeon-si (KR)

(21) Appl. No.: 12/063,078

(22) PCT Filed: Aug. 8, 2006
(86) PCT No.: PCT/KR2006/003102

§ 371 Date: Feb. 6, 2008

(30) Foreign Application Priority Data
Aug. 8, 2005 (KR) 10-2005-0072312

(51) Int. Cl. B01D 71/56; B29C 47/06

(52) U.S. Cl. 210/500.38; 264/516

(57) ABSTRACT

Disclosed are a nanofiltration composite hollow fiber membrane and a method of manufacturing the same. The nanofiltration composite hollow fiber membrane includes a reinforcement (1) which is a tubular braid, a polymeric resin thin film (2) coated on the outer surface of the reinforcement (1), and a polyamide active layer (3) formed on the outer surface of the polymeric resin thin film. The present invention has an advantage of an excellent strength and an increase in membrane area relative to an installation area.

### TECHNICAL FIELD

The present invention relates to a nanofiltration composite hollow fiber membrane (hereinafter we refer it as “nanofiltration composite hollow fiber membrane”) and a method of manufacturing the same, and more particularly, to a nanofiltration composite hollow fiber membrane, which has excellent strength and is able to increase a membrane area because it is reinforced by a reinforcement of tubular braid and a polyamide active layer is formed on the surface thereof by interfacial polymerization, and a method of manufacturing the same.

Hereinafter, in the present invention, a hollow fiber membrane or separation membrane, which has an active layer sufficient for effectively filtering multivalent ions while allowing the passage of monovalent ions, is referred to as a nanofiltration hollow fiber membrane or nanofiltration separation membrane.

Recently, with emphasis on the environment, there is an increasing demand for polymer separation membranes in the field of water treatment. Among them, the demand for a nanofiltration separation membrane having an intermediate property between an ultrafiltration membrane and a reverse osmosis membrane is gradually increasing. The nanofiltration separation membrane has a superior exclusion performance, which the ultrafiltration membrane cannot have, because it can filter multivalent ions while allowing the passage of monovalent ions, and at the same time, the nanofiltration separation membrane is excellent from an economical standpoint because it shows a relatively high permeation flux as compared to the reverse osmosis membrane.

### BACKGROUND ART

Heretofore, a variety of attempts for manufacturing a nanofiltration separation membrane have been made. For example, in U.S. Pat. No. 4,872,894, No. 5,614,099 and so on, a nanofiltration separation membrane was manufactured by forming an active layer on a film type porous support material by interfacial polymerization. However, in such a prior art technique, which is applied by modifying a conventionally known technique of a reverse osmosis membrane, a membrane of the same flat film type as that of a reverse osmosis membrane is manufactured. Typically, such prior art nanofiltration separation membrane and reverse osmosis membrane have limitations in that the permeation flux is low as compared to an ultrafiltration membrane despite their excellent exclusion performance, and a throughput per installation area is small upon actual application of the membranes.

In the meantime, Japanese Patent Laid-Open No. 2001-212562 discloses a method of manufacturing a nanofiltration separation membrane by forming a polyamide membrane on the surface of a polysulfone hollow fiber membrane. However, the nanofiltration separation membrane manufactured by the above method is problematic in that the strength is too low because it has no reinforcement.

### DISCLOSURE OF THE INVENTION

### Technical Problem

To solve the above-described problems, the present invention aims to increase a membrane area per installation area in comparison with a flat film type nanofiltration separation membrane produced in a spiral wound type module and accordingly increase throughput by manufacturing a hollow fiber membrane type nanofiltration separation membrane.

Additionally, the present invention aims to manufacture a membrane with excellent strength by using a tubular braid having excellent mechanical properties, and at the same time, apply a variety of fouling prevention techniques such as back washing, air washing, etc. used in a conventional hollow fiber membrane treatment.

Meanwhile, unlike the process of manufacturing a flat nanofiltration membrane, in a method of manufacturing a nanofiltration composite hollow fiber membrane according to the present invention, a nanofiltration composite hollow fiber membrane can be manufactured in a continuous manufacture process by a continuous supply of tubular braid, thereby ensuring a high productivity.

### Technical Means to Solve the Problem

To achieve the above-described objects, there is provided a nanofiltration composite hollow fiber membrane according to the present invention, comprising: a reinforcement 1 which is a tubular braid; a polymeric resin thin film 2 coated on the outer surface of the reinforcement 1; and a polyamide active layer 3 formed on the outer surface of the polymeric resin thin film.

Additionally, there is provided a method of manufacturing a nanofiltration composite hollow fiber membrane according to the present invention, including the steps of: (i) preparing a spinning dope by stirring and dissolving a polymeric resin in an organic solvent; (ii) spinning the spinning dope through a double tube nozzle while passing a tubular braid through the center portion of the double tube nozzle, to thus coat the spinning dope on the outer surface of the tubular braid and extrude the same in the air; (iii) coagulating the tubular braid coated with the spinning dope in a coagulation bath, and washing and drying the same; (iv) immersing the coated and dried tubular braid in an immersion bath containing a polyfunctional amine compound and then passing the same through a squeezing roller to remove an excessive amount of dipping solution; and (v) immersing the immersed tubular braid in an immersion bath containing a polyfunctional acyl halide compound for interfacial polymerization.

Hereinafter, the present invention will be described with reference to the accompanying drawings.

First, a nanofiltration composite hollow fiber membrane of this invention comprises: a reinforcement 1 which is a tubular braid; a polymeric resin thin film 2 coated on the outer surface of the reinforcement 1; and a polyamide active layer 3 formed on the outer surface of the polymeric resin thin film.

FIG. 1 is a cross sectional pattern diagram of a nanofiltration composite hollow fiber membrane according to the present invention.

A cross section of the polymeric resin film 2 is of a sponge structure in which fine holes having a hole diameter smaller than 10 μm are formed as shown in FIG. 2. Such a structure can be formed by adjusting the thermodynamic stability of a spinning dope for coating the polymeric resin thin film. For instance, it is possible to prepare a polymeric resin thin film 2 having a cross section of a sponge structure by incorporating 1 to 10% by weight of water or polyethylene glycol in the spinning dope. The polymeric resin thin film 2 having a cross section of a sponge structure has excellent mechanical properties as there exist no macrovoids causing mechanical defects. FIG. 2 is a scanning electron micrograph showing a cross sectional structure of the polymeric resin thin film 2.

In order to enhance mechanical strength and water permeability, it is preferable that the thickness of the polymeric resin thin film 2 is smaller than 0.2 mm and the distance of penetration of the polymeric resin thin film 2 into the reinforcement is less than 30% of the thickness of the reinforcement 1.

Preferably, the polymeric resin thin film 2 is one resin selected from the group consisting of polysulfone resin, polyether sulfone resin and sulfonated polysulfone resin.

The polyamide active layer 3 is formed by interfacial polymerization of a polyfunctional amine compound and a polyfunctional acyl halide compound.

In the polyamide active layer 3, a dendritic polymer serving as a polyfunctional compound may be introduced.

The dendritic polymer serving as a polyfunctional compound comprises dendritic polymer having amine substituted terminal or dendritic polymer having acid chloride substituted terminal.

The dendritic polymer serving as a polyfunctional compound is a dendritic polymer whose end has been substituted with amine or a dendritic polymer whose end has been substituted with acid chloride.

Preferably, the outer diameter of the nanofiltration composite hollow fiber membrane of this invention is 1 to 3 mm.

If the above outer diameter is smaller than 1 mm, this makes the preparation of a tubular braid difficult. A reduction in inner diameter resulting from the reduction in outer diameter may lead to a problem of pressure loss because of an increase in the resistance of flow caused when permeable water permeated through the active layer 3 flows in the hollow fiber membrane. In the meantime, if the outer diameter is greater than 3 mm, it is not possible to integrate many more hollow fiber membranes in a module, which may reduce the membrane area per installation area.

Next, a method of manufacturing a nanofiltration composite hollow fiber membrane of the invention will be described in more detail.

The method of manufacturing a nanofiltration composite hollow fiber membrane comprises the steps of: (i) preparing a spinning dope by stirring and dissolving a polymeric resin in an organic solvent; (ii) spinning the spinning dope through a double tube nozzle while passing a tubular braid through the center portion of the double tube nozzle, to thus coat the spinning dope on the outer surface of the tubular braid and extrude the same in the air; (iii) coagulating the tubular braid coated with the spinning dope in a coagulation bath, and washing and drying the same; (iv) immersing the coated and dried tubular braid in an immersion bath containing a polyfunctional amine compound and then passing the same through a squeezing roller to remove an excessive amount of dipping solution; and (v) immersing the immersed tubular braid in an immersion bath containing a polyfunctional acyl halide compound for interfacial polymerization.

More preferably, in the present invention, a nanofiltration composite hollow fiber membrane is manufactured by continuously carrying out the steps (i) to (v).

In the present invention, a spinning dope of polymeric resin is coated on a reinforcement 1 of a tubular braid to form a polymeric resin thin film 2, and a polyamide active layer 3 is formed on the surface of the polymeric resin thin film 2 by interfacial polymerization, thereby manufacturing a nanofiltration composite hollow fiber membrane.

First, polymeric resin is stirred and dissolved in an organic solvent to prepare a spinning dope.

The spinning dope is preferably comprised of 10 to 50% by weight of polymeric resin and 50 to 90% by weight of an organic solvent, and may contain a hydrophilic additive.

In order to prepare a polymeric resin thin film 2 having a cross section of a sponge structure, more preferably, 1 to 10% by weight of water or polyethylene glycol is incorporated in the spinning dope.

However, the present invention does not specifically limit the composition ratio of the spinning dope. The polymeric resin includes polysulfone resin, polyether sulfone resin, sulfonated polysulfone resin, etc. The organic solvent includes dimethyl acetamide, dimethylformamide or a mixed solution thereof.

Next, in order to form a polymeric resin thin film 2 by coating the spinning dope on the reinforcement 1 of the tubular braid, the tubular braid is passed through the center portion of a double tube nozzle, and at the same time the spinning dope is spun through the double tube nozzle to coat the spinning dope on the outer surface of the tubular braid and discharged in the air, and then the tubular braid is coagulated in a coagulation bath, washed and dried.

Next, in order to form a polyamide active layer 3 by interfacial polymerization on the surface of the polymeric resin thin film 2 coated on the surface of the tubular braid, the coagulated and dried tubular braid (coated with the polymeric resin thin film) is immersed in an immersion bath containing a polyfunctional amine compound, and passed through a squeezing roller to remove an excessive amount of dipping solution, and then the immersed tubular braid (coated with the polymeric resin thin film) is immersed in an immersion bath containing a polyfunctional acyl halide compound for interfacial polymerization.

The polyfunctional amine compound may include an aromatic amine substituent. The polyfunctional acyl halide compound may include aromatic acyl halide. The polyfunctional amine compound may include meta phenylene diamine, piperazine, triaminobenzene and so on. The polyfunctional acyl halide compound may include trimesic acid chloride, isophthaloyl dichloride and so on.

In addition, a variety of additives such as acid, basic tertiary amine, amine acid, nonpolar solvents, alcohol, ether, ketone, etc. may be contained in each of the immersion baths.

In addition, dendritic polymer serving as a polyfunctional compound may be added to each or all of the immersion baths.

The above-described procedure may be continuously performed starting from the step of supplying a tubular braid to a double tube nozzle until the step of forming a final active layer. Alternately, a final nanofiltration hollow fiber membrane may be manufactured by interfacial polymerization by winding a tubular braid coated with a polymeric resin thin film, then unwinding the same and then passing it through an immersion bath. Such a continuous procedure enables mass production of products, and thus results in a great advantage in terms of reduction of manufacturing costs.

The nanofiltration composite hollow fiber membrane manufactured according to the present invention can be used for large-scale water purification or small-scale water supply because it shows an excellent strength and ensures a high throughput per installation area.

### ADVANTAGEOUS EFFECTS

The present invention can increase a membrane area per installation area in comparison with a flat film type nanofiltration separation membrane produced in a spiral wound type module and, accordingly, increase throughput by manufacturing a hollow fiber membrane type nanofiltration separation membrane.

Additionally, the present invention can manufacture a membrane with excellent strength, apply a variety of fouling prevention techniques such as back washing, air washing, etc. used in a conventional hollow fiber membrane treatment, and increase a washing effect when washing through a gap clearance of the membrane by using a tubular braid having excellent mechanical properties.

Meanwhile, unlike the process of manufacturing a flat film type nanofiltration separation membrane, in a method of manufacturing a nanofiltration composite hollow fiber membrane according to the present invention, a continuous manufacture process is applicable by a continuous supply of tubular braid, thereby ensuring a high productivity.

### BRIEF DESCRIPTION OF THE DRAWINGS

These and other features, aspects, and advantages of preferred embodiments of the present invention will be more fully described in the following detailed description, when taken in conjunction with accompanying drawings. In the drawings:

FIG. 1 is a cross sectional pattern diagram of a nanofiltration composite hollow fiber membrane according to the present invention; and

FIG. 2 is a scanning electron micrograph showing a cross sectional structure of a polymeric resin thin film 2 of FIG. 1.

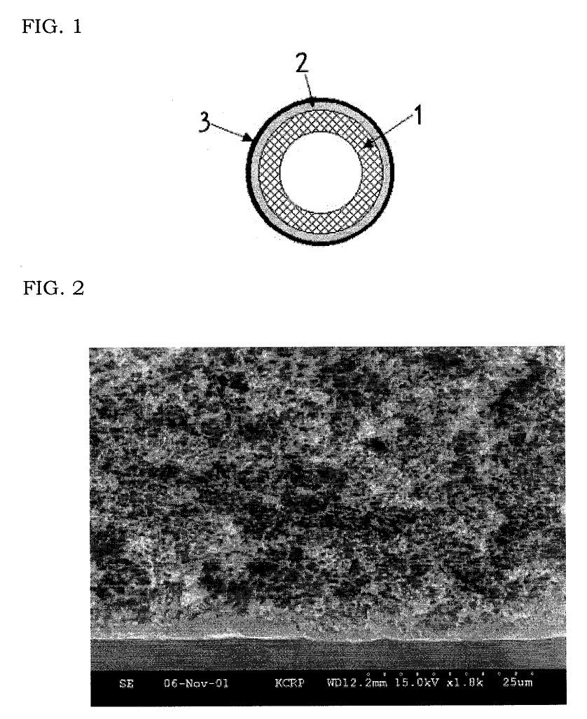

### BEST MODES FOR CARRYING OUT THE INVENTION

The present invention will be explained in detail through the following examples and comparative examples; however, the present invention is not intended to be limited to examples and comparative examples.

### Example 1

14% by weight of polysulfone was stirred and dissolved in 84% by weight of dimethylformamide (organic solvent), and then 2% by weight of polyethylene glycol was added thereto, to prepare a transparent spinning dope. Next, the spinning dope was supplied to a double tube nozzle having a diameter of 2.38 mm Φ while passing a tubular braid having an outer diameter of 2 mm through the center portion of the nozzle, to thus coat the spinning dope on the surface of the tube nozzle, and the tubular braid was coagulated with water and then washed and dried. The coated and dried tubular braid was immersed in an immersion bath having an aqueous solution containing 2% by weight of piperazine then passed through a rubber roll to remove an excessive amount of the solution, and then was immersed in an immersion bath having an n-decane solution containing 0.1% by weight of trimesoyl chloride (TMC) and reacted to form an active layer. Thereafter, the tubular braid was dried after the removal of the solution to manufacture a nanofiltration composite hollow fiber membrane.

The thus-manufactured nanofiltration composite hollow fiber membrane was potted in a commercial module case having a diameter of 6.4 cm and a length of 1 m. A packing density defined as the ratio of the cross sectional area occupied by hollow fiber membranes to the cross sectional area of the module case was set to 50% to determine the number of hollow fiber membranes. A permeability experiment was carried out using city water at an ambient temperature (25° C.).

### Comparative Example 1

An active layer was formed on a film type porous support by interfacial polymerization in the same method as in Example 1 to manufacture a flat film type nanofiltration separation membrane. A permeability experiment was carried out under the same condition as in Example 1 by using a commercial nanofiltration separation membrane module having the same module diameter and length as in Example 1.

### Comparative Example 2

16% by weight of polysulfone was stirred and dissolved in 84% by weight of dimethylformamide (organic solvent) to prepare a transparent spinning dope. Next, the spinning dope was supplied to a double tube nozzle having a diameter of 2.38 mm Φ while passing water serving as a core solution through the center portion of the nozzle, to thus form a hollow fiber membrane, and then the hollow fiber membrane was coagulated with water and then washed and dried. The coated and dried hollow fiber membrane was immersed in an immersion bath having an aqueous solution containing 2% by weight of piperazine then passed through a rubber roll to remove an excessive amount of the solution, and then was immersed in an immersion bath having an n-decane solution containing 0.1% by weight of trimesoyl chloride (TMC) and reacted to form an active layer. Thereafter, the hollow fiber membrane was dried after the removal of the solution to manufacture a nanofiltration composite hollow fiber membrane.

The thus-manufactured nanofiltration composite hollow fiber membrane was potted in a commercial module case having a diameter of 6.4 cm and a length of 1 m as in Example 1. A packing density defined as the ratio of the cross sectional area occupied by hollow fiber membranes to the cross sectional area of the module case was set to 50% to determine the number of hollow fiber membranes. A permeability experiment was carried out using city water at an ambient temperature (25° C.).

To evaluate the permeation flux, membrane area and washing effect of the nanofiltration composite hollow fiber membrane of the present invention and commercial nanofiltration membrane, the membrane area, tensile strength and permeability per module of Example 1 and Comparative Examples 1 and 2 were measured. To compare the module washing effect, a degree of recovery as the result of washing each module was inspected. At this time, the washing was carried out at a point of time when the flux became 15% of the initial flux because of the progress of contamination of the membrane caused by a long-duration permeability experiment.

In the present invention, various physical properties were measured in the following method.

Membrane Area

The membrane area of the separation membrane actually inserted into the module was calculated.

Permeability

A permeability experiment was carried out using city water under the condition of an ambient temperature (25° C.) and a pressure of 400 kPa.

Washing Effect

After carrying out the permeability experiment, each module was washed using a washing solution (ultra pure water containing 1% of citric acid) at a point of time when the flux was reduced to 80% of the initial flux, and a permeability experiment was re-applied.

Tensile Strength

The tensile strength of a hollow fiber membrane was measured by a tensile tester. A tensile test was performed under an ambient temperature under the condition of a grip distance of 10 cm and a crosshead speed of 3 cm/min with respect to a single strand of a hollow fiber membrane.

TABLE 1

| | Example | Comparative | Comparative |
|---|---|---|---|
| Section | 1 | Example 1 | Example 2 |
| Membrane Area | 3 m² | 2.5 m³ | 3 m³ |
| Permeability Per Module | 2.6 m³/day | 2.1 m³/day | 2.7 m³/day |
| Permeability Recovery | 94% | 91% | 92% |
| Rate After Washing | | | |
| Tensile strength | 26 | 28 | 0.55 |
| (kgf/one strand of | | | |
| hollow fiber membrane) | | | |

In Table 1, in a case that a membrane is potted in a module case of the same dimension, a hollow fiber membrane type separation membrane can be potted so as to have a higher membrane area, and as a result it can be seen that the permeability per module is high, thereby increasing the throughput per installation area in comparison with a conventional flat film type nanofiltration separation membrane. Further, the conventional flat film type nanofiltration separation membrane is a spiral wound type module, in which the separation membrane cannot have a gap clearance, while the hollow fiber membrane type separation membrane can have a gap clearance in the module, and thus is confirmed to be more effective in washing by a permeability recovery rate.

In the meantime, the composite hollow fiber membrane with no reinforcement of Comparative Example 2 is very low in tensile strength as compared to Example 1 and Comparative Example 1 in which there is a reinforcement.

### INDUSTRIAL APPLICABILITY

The present invention can be used for a water purifier for home use, a water purifier for industrial use, a seawater desalination facility, etc. by having an advantage of an excellent strength and an increase in membrane area relative to an installation area.

1. A nanofiltration composite hollow fiber membrane, comprising:
a reinforcement (1) which is a tubular braid;
a polymeric resin thin film (2) coated on the outer surface of the reinforcement (1); and
a polyamide active layer (3) formed on the outer surface of the polymeric resin thin film.

2. The nanofiltration composite hollow fiber membrane of claim 1, wherein a cross section of the polymeric resin film (2) is of a sponge structure in which fine holes having a hole diameter smaller than 10 μm, are formed.

3. The nanofiltration composite hollow fiber membrane of claim 1, wherein the polymeric resin thin film (2) is one resin selected from the group consisting of polysulfone resin, polyether sulfone resin, and sulfonated polysulfone resin.

4. The nanofiltration composite hollow fiber membrane of claim 1, wherein the polyamide active layer (3) is formed by interfacial polymerization of a polyfunctional amine compound and a polyfunctional acyl halide compound.

5. The nanofiltration composite hollow fiber membrane of claim 1, wherein a dendritic polymer serving as a polyfunctional compound is introduced in the polyamide active layer (3).

6. The nanofiltration composite hollow fiber membrane of claim 1, wherein the outer diameter of the nanofiltration composite hollow fiber membrane is 1 to 3 mm.

7. A method of manufacturing a nanofiltration composite hollow fiber membrane, comprising:
(i) preparing a spinning dope by stirring and dissolving a polymeric resin in an organic solvent;
(ii) spinning the spinning dope through a double tube nozzle while passing a tubular braid through the center portion of the double tube nozzle, to thus coat the spinning dope on the outer surface of the tubular braid and extrude the same in the air;
(iii) coagulating the tubular braid coated with the spinning dope in a coagulation bath, and washing and drying the same;
(iv) immersing the coated and dried tubular braid in an immersion bath containing a polyfunctional amine compound and then passing the same through a squeezing roller to remove an excessive amount of dipping solution; and
(v) immersing the immersed tubular braid in an immersion bath containing a polyfunctional acyl halide compound for interfacial polymerization.

8. The method of claim 7, wherein the steps (i) to (v) are carried out continuously.

9. The method of claim 7, wherein 1 to 10% by weight of one selected from the group consisting of water and polyethylene glycol is added in the spinning dope.
